(19) United States
(12) Patent Application Publication
(10) Pub. No.: US 2008/0232216 A1
(43) Pub. Date: Sep. 25, 2008

(54) Focus Control Scheme with Jumping Focal Point

(75) Inventors: Ferry Zijp, Eindhoven (NL); Martinus Bernardus Van Der Mark, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,182

(22) PCT Filed: Jan. 10, 2005
(86) PCT No.: PCT/IB2005/050097

§ 371 Date: Jul. 14, 2006

(30) Foreign Application Priority Data
Jan. 20, 2004 (EP) 04100166.0

(51) Int. Cl. G11B 5/58

(52) U.S. Cl. 369/53.23

(57) ABSTRACT

The present invention relates to a focus control apparatus and method of controlling focus of a radiation beam onto a first spatial level of a record carrier, wherein a focus control loop is locked onto a reflection signal obtained from a second spatial level located at a predetermined distance from said first spatial level, and is then opened to move an objective means towards the second spatial level by a predetermined amount related to the predetermined distance. This stepwise procedure enlarges the margin for mechanical overshoot and hence reduces the risk of bumping into the disc. Additionally, no ambiguous focus error signals are detected and robustness of initial focusing is improved if a thin transparent cover layer is present.

The present invention relates to a focus control method and apparatus for controlling an objective means, e.g. a focusing lens, to focus a radiation beam onto a predetermined spatial level of a record carrier, such as an optical disc.

To read or write on a record carrier or data storage medium, e.g. an optical data storage medium such as a CD (Compact Disc) or DVD (Digital Versatile Disc), a radiation beam, e.g. a laser beam, has to be focused onto the storage medium. The effective optical distance from the focusing lens to the recording surface has to be kept constant. To achieve this, the focusing lens must be brought in proximity to the recording surface, for example by means of an actuator carrying the focusing lens. This actuator is part of a servo loop and is driven by currents which are derived from a focus error signal (FES) which in turn is derived from light reflected at the storage medium, e.g., optical disc. At some initial time, the servo loop is closed and, from then on, the laser beam is kept in focus on the storage medium at all times, following bending (flutter) and thickness variations (both of these give rise to so-called axial run-out) and compensating for accelerated motion of parts of the system due to for example a mechanical shock.

For the future generation of optical storage systems, it is expected that the numerical aperture of the objective will raise to NA=0.85 or even to NA=0.95 to thereby improve resolving power. Despite this tendency of the objective to increase in size, however, the increasing demand for high rate data and access time forces the total mass of the objective to shrink. This can only be accomplished if the focal length and hence the free working distance (FWD) is reduced. As a consequence, the smaller FWD will ultimately require that the disc will be read out and/or written from the side where the information layer is provided, i.e. “first surface”, possibly through a thin cover layer. This is in contrast to conventional optical discs like CDs, where the information layer is illuminated through the 1.2 mm substrate.

Another reason to change to the so-called “first-surface recording” is the tilt margin in case of the conventional “substrate incident recording” to prevent both spherical aberration and comatic wave front aberration as a result of refraction by the substrate. In case of a high-NA objective, the highly curved wave front narrows down significantly the maximum allowed tilt and thus makes the substrate incident recording less practical.

The provision of the thin cover layer may be useful for at least three reasons. Firstly, scratching of the data layer is avoided, so that the robustness of the stored data can be enhanced. Secondly, the cover layer is expected to help cooling the storage layer due to its direct thermal contact and higher heat capacity than air, and to help shielding the objective lens from thermal effects, such as water desorption, due to high temperatures of the storage layer surface, in particular during write sequences. Thirdly, the cover layer may serve as anti-reflection coating.

In magneto-optical recording, the reflectivity of the data storage layer and cover layer are of the same order of magnitude, typically between 5% and 15%. Therefore, additional reflection signals are obtained from the surface of the cover layer. Optical coatings to reduce the reflectivity of the cover layer are complicated due to the high NA of the objective lens which results in a large variation in direction of the incident k-vector. Moreover, optical discs are cheap removable media and the costs allowed to control surface quality, disc curvature and anti-reflection coatings are thus limited.

For the above reasons, future generation optical storage systems will require initiation of focus lock at close distance to a fast moving disc surface which contains a thin transparent cover layer. Additionally, the optical reflection by the cover layer may be significant in comparison to the reflection by the storage or data layer.

However, if focus locking is initiated at such close distances to the fast moving disc surface which contains the transparent cover layer, a problem occurs when the cover layer thickness is comparable to the focus locking range (FLR), which corresponds to a straight part of a slope in the FES curve.

FIG. 2 shows a schematic diagram indicating a simple FES curve as obtained for an optical disc without cover layer in first-surface recording. The horizontal axis indicates the amount of defocus (df). As an example, the FLR may be in the range of 8 μm. A similar curve will be observed for a disc with very thin transparent cover layer, in particular if the thickness of the cover layer is small compared to the wavelength of the focused laser beam.

If first-surface recording is performed for such discs, ambiguous feedback signals may be provided to the focus servo system. Moreover, the axial motion of the disc surface may be too fast for the servo to close properly, or the bandwidth of the system may be too small to keep the focus overshoot upon initial servo closure within the FLR. In particular, axial run-out of the disc due to thickness variation of the disc, which amount to e.g. about 30 μm for a DVD, combined with disc bending (flutter) which amounts to about 300 μm for a DVD, leads to a variation of the axial focus distance for an open servo loop by more than the FWD in the case of a high NA focusing objective, typically FWD≅15 μm for the specific example considered here. If the cover layer thickness is comparable to the FLR, overlap of the FES curves from the air to cover layer and the cover layer to storage layer will occur. Then, proper closing of the focus servo loop can no longer be guaranteed, and in addition, if the loop can be closed successfully, it is by no means certain, due to focus actuator overshoot, that the focus is actually locked on the data layer.

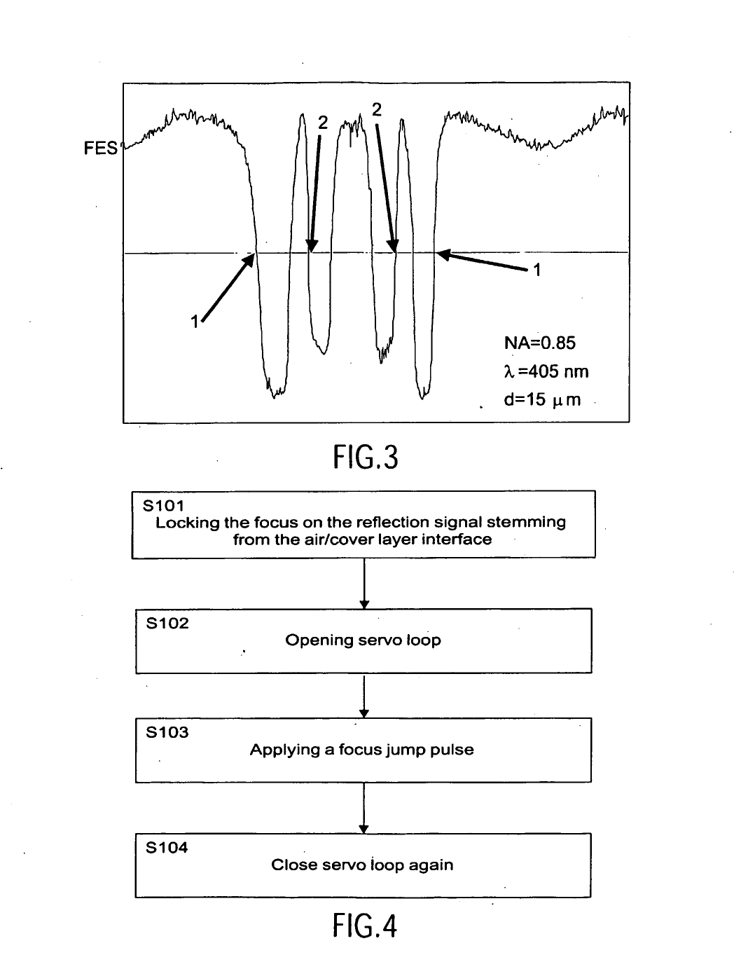

FIG. 3 shows a schematic diagram indicating a focus error curve of a disc with a 15 μm cover layer as for an optical pick-up unit with NA=0.85 and λ=405 nm. A first type of zero crossings 1 corresponds to correct focussing with the spot focussed on the recording stack or data layer, while a second type of zero crossings 2 corresponds to focussing with the spot focussed on top of the cover layer. Here, the optical disc has a 15 μm thin transparent cover layer covering the recording surface or data layer. Due to the fact that this cover layer is fairly thin, the FES contains false zero crossings 2 corresponding to focussing on top of the cover layer instead of the data layer. The servo control loop is switched on when a zero crossing is detected and, if this happens to be one of the false zero crossings 2, the laser beam will be undesirably focussed on top of the cover layer. It is noted that zero crossings at which the slope of the FER has the opposite sign are also undesirable, since the actuator will hit the disc in its attempt to close the servo loop upon detection of such a crossing.

It is therefore important to position the disc in the axial direction in such a way that only useful zero crossings are observed before closing the focus servo loop. In the particular example of FIG. 3, the focussing lens was brought very close to a stationary disc, and then it was first moved away from the disc. This is contrary to what would happen in a normal optical disc drive, where the focussing lens approaches the disc from far away, and hence observes the FES zero crossing first. It is noted that the direction in which the signal crosses zero depends on the direction in which the focussing lens is moving, which implies that the right direction must be preset, e.g. in the electronics, to guarantee proper closure of the loop. If, unexpectedly, the focussing lens moves in the wrong direction, i.e. away from the optical disc instead of towards the optical disc, for example, while the focus servo loop hasn't been closed yet, the focus servo loop may close at an intermediate zero crossing, causing the focussing lens to bump into the disc.

Document WO 03/032298 A2 discloses an optical disc player with focus pull-in function, wherein a focus pull-in operation is executed while avoiding that the objective lens comes into contact with the optical disc. The objective lens is forcedly moved gradually from a position away from the surface of the optical disc and outside the capture range of the focus servo loop, towards the surface of the optical disc. The movement is stopped when the objective lens reaches the capture range of the focus servo loop or the distance between objective lens and disc surface is at a minimum or when the disc is moving away. In particular, a control signal taken from a read sum signal controls the movement of the objective lens towards the data layer without stopping at the air/cover layer interface. The objective is thus promptly pulled in to a position near the capture range of the focus servo loop related to the data layer. The read sum signal contains two peaks, one at a time point corresponding to the disc surface and another one at a later time point corresponding to the data layer. However, in case of the above first-surface recording type, due to the small thickness of the cover layer, only the sum of both peaks will be visible. As consequence, the procedure described in this prior art is no longer useful.

It is therefore an object of the present invention to provide a focus control apparatus and method, by means of which proper focussing on the data layer can be achieved even in case of a first-surface recording with thin cover layer.

This object is achieved by a focus control apparatus as claimed in claim 1 and a method as claimed in claim 11.

Accordingly, the solution is based on a new insight that it is possible to increase significantly the allowable mechanical overshoot to match the defocus margins as set by the FLR and the relative position of data layer, disc surface and focusing lens. Extra mechanical margin can be obtained by dividing the process of focus locking on the data layer into a stepwise procedure, wherein the focus is firstly locked onto a reflection signal stemming from the second spatial level, and then, secondly opening the servo loop and moving the objective means towards the record carrier by an amount related to the distance between the second spatial level and the desired first spatial level. The result is that the radiation beam is now focused on the desired first spatial level when, thirdly, the servo loop is closed again. Thereby, the relative speed of the objective means, e.g. optical head containing the focusing lens, with respect to the disc can be made zero before actually moving or jumping the focal point from the cover layer to the information or data layer. Detection of ambiguous FESs can thus be prevented, as the first zero crossing or any other preset signal level is always the correct zero crossing to start with. The proposed procedure enlarges the margin for mechanical overshoot, which is particularly important in case of small FWDs, and hence reduces the risk of bumping into the disc, which again reduces the risk of damaging the disc or objective lens due to a head crash. Therefore, the proposed control scheme is superior to the initially described prior art in case of a thin cover layer with a distance of a few microns and in cases where the FWD of the objective is very small.

According to a first aspect, the first spatial level may correspond to a surface of the record carrier and the second spatial level may correspond to a data layer of the record carrier.

According to a second aspect, the first spatial level may correspond to a first negative-slope zero crossing of a focus error signal detected by the detection means, and the second spatial level may correspond to a second negative-slope zero crossing of the focus error signal.

Thereby, two strategies can be provided for obtaining proper focussing on the data layer. In case of a situation where two crossing signal levels for servo lock can be preset, the focus servo loop can be first locked onto the first spatial level and then onto the second spatial level. In case of a situation where a single reference signal level can be maintained, such as the zero level, the focus servo may first be locked onto the first negative-slope zero crossing and then onto the second negative-slope zero crossing. This second aspect may be advantageous and useful for thicker types of cover layers. The move of the objective means by the predetermined amount may be achieved by a jump operation initiated by the focus control means. In particular, the jump operation may be initiated by the focus control means by applying a predetermined jump pulse to the actuator means. Thereby, the actuator can swiftly push the objective means towards the disc by the required amount which reduces focusing delay. The predetermined amount may correspond to an effective optical thickness between the first and second spatial levels.

The focus control means may be configured to finally close the focus control loop again after the move of the objective means by the predetermined amount.

Furthermore, the focus control means may be configured to control the actuator means to reduce the relative velocity between the objective means and the record carrier to zero, when the locking to the second spatial level has been detected. This reduces the risk of a head crash.

Further advantageous modifications are defined in the dependent claims.

The present invention will now be described on the basis of the preferred embodiments with reference to the accompanying drawings, in which:

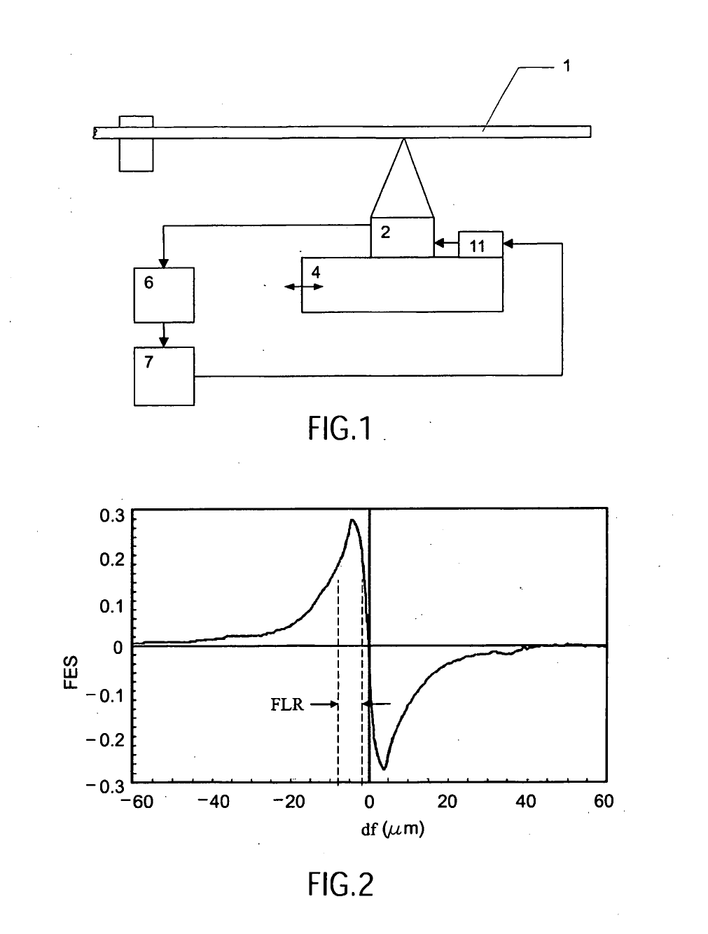

FIG. 1 shows a schematic block diagram of a focus control device according to the preferred embodiments,

FIG. 2 shows a diagram indicating an FES curve for a disc in case of first-surface recording;

FIG. 3 shows a diagram indicating an FES curve of a disc with a cover layer and several zero crossings;

FIG. 4 shows a stepwise focus control method according to the preferred embodiments;

FIG. 5 shows a schematic diagram indicating dimensional relationships when focusing on top of a cover layer and on a recording stack;

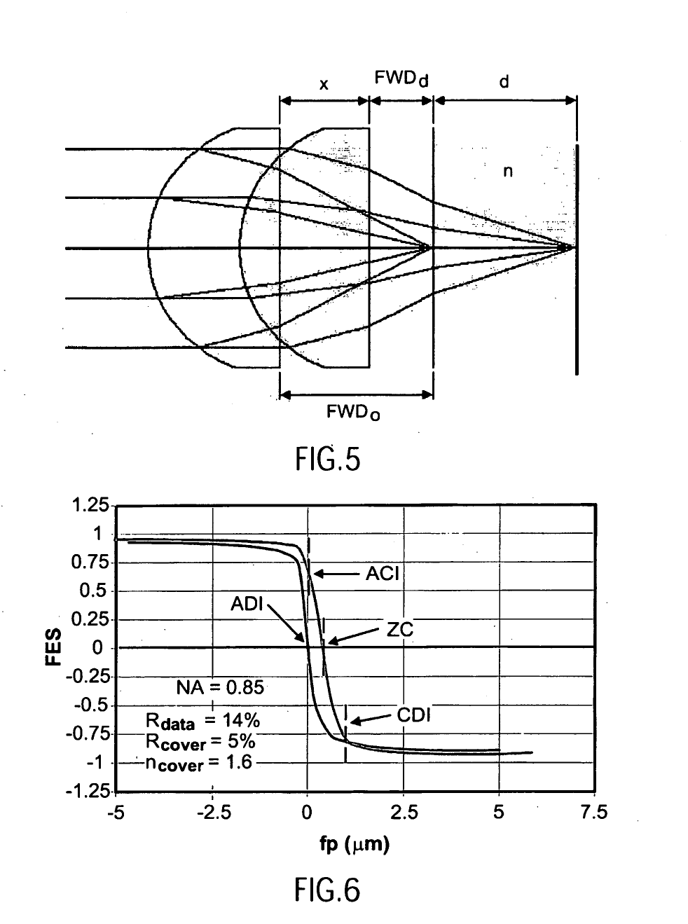

FIG. 6 shows a diagram indicating normalized FES curves for a disc without cover layer and a disc with very thin transparent cover layer;

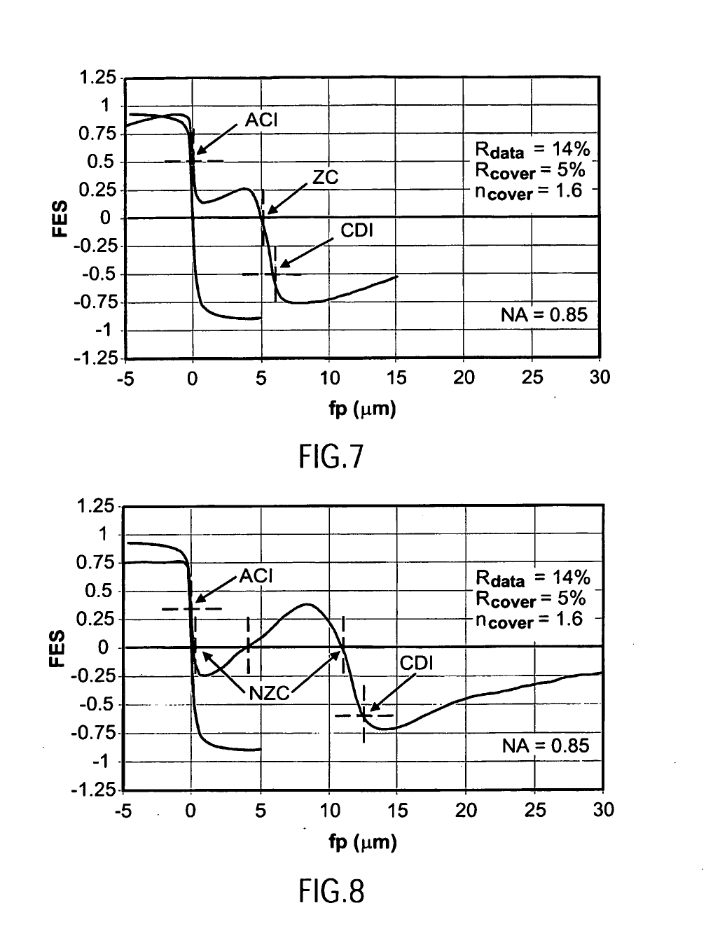

FIG. 7 shows a diagram indicating distorted double S curves of an FES for a disc with a cover layer which is several times thicker than the focal depth; and

FIG. 8 shows a diagram indicating a distorted double S-curve of an FES with two negative slopes and two zero crossings.

The preferred embodiments will now be described on the basis of a magneto-optic domain-expansion recording technique, such as MAMMOS (Magnetic AMplifying Magneto-Optical System).

FIG. 1 shows a focus control device in which the focus control scheme according to the preferred embodiments can be implemented. The focus control device comprises an optical pickup unit with a movable carriage or sledge 4 for moving the optical pickup unit in radial direction of an optical disc 1 on which a generated laser beam is to be focused, and an optical head 2 which focuses the laser beam onto the optical disc 1.

Furthermore, a focus control circuit is provided, which comprises a focus evaluator 6 which produces a focusing error signal (FES) based on the output signal of the optical head 2. The FES is supplied to a focus controller 7 which generates a focus controller voltage or current supplied to a focus actuator 11 arranged to control an objective means, such as a focusing lens, of the recording head 2 so as to be moved in a perpendicular direction with respect to the surface of the optical disc 1. The focus control circuit consisting of the focus evaluator 6, the focus controller 7 and the focus actuator 11 is arranged as a focus servo loop which performs a feedback control so as to minimize the FES. Accordingly, when the focusing lens of the optical head 2 is moved in response to the focus control voltage supplied from the focus controller 7 to the focus actuator 11, it is moved to adjust the focusing state of the optical head 2.

It is to be noted here that any other suitable mechanism for adjusting the focus of the optical head by an actuator means based on a focus controller signal can be applied in the preferred embodiments. It is also to be noted that any other suitable error signal than the FES may be used to control the focus on the optical disk.

According to the preferred embodiments, the allowable mechanical overshoot to match the defocus margins, as set by the FLR and the relative position of data layer, disc surface and focusing lens, can be increased significantly. The FLR is determined by the interval of the steep negative slope in the FES curve shown in FIG. 2. Extra mechanical margin can be obtained by dividing the process of focus locking on the data into a stepwise process, e.g. a 3-step process as described in the following.

FIG. 4 shows a schematic flow diagram of a focus control procedure according to the preferred embodiments. The idea is that when the optical head 2 and/or the focusing lens approach the disc 1, the focus is locked onto the reflection signal stemming from the air/cover layer interface in step S101 and then, in step S102, the focus servo loop is opened and in step S103 a “focus jump pulse” is applied to the focus actuator 11 by the focus controller 7 at a suitable moment to swiftly push the optical head 2 and/or the focusing lens towards the disc 1 by an amount equal to the effective optical thickness of the cover layer, i.e. thickness of the cover layer divided by its refractive index n. The result is, that the focal point is now placed on the storage layer. In a subsequent step S104, the focus servo loop is closed again, e.g. under control of the focus controller 7, possibly with a different offset value, to keep the focal point at this position. It is noted, that steps S102 and S103 may be performed simultaneously or one after the other.

FIG. 5 shows a schematic diagram indicating two focusing positions or focal points of the focusing lens, a first focal point on top of a cover layer of thickness d≈15 μm with a free working distance FWD₀≈16 μm, and a second focal point on the recording stack or data layer in which a much smaller free working distance FWD_{d}≈6 μm is provided. Hence, in this case, the difference in FWD is x≈d/n≈10 μm, if the refractive index n=1.6. The suggested focus control procedure is particularly advantageous when the thickness of the cover layer takes away a substantial part of the FWD, i.e. if the difference of the FWD₀ without cover and FWD_{d} with cover is larger than FWD_{d} with cover, that is FWD₀−FWD_{d}>FWD_{d}.

The preferred embodiments are thus advantageous in that the relative speed of the optical head 2 containing the focusing lens with respect the disc 1 can be made zero before actually jumping or moving their focus position or focal point from the cover layer onto the information or data layer.

In the following some typical examples of FES curves are described in more detail. The parameter values chosen are realistic for MAMMOS systems as used in the preferred embodiments.

For the disc 1, the reflected intensity from the data layer may be about R=14% which is typical for magneto optical MO recording, and the reflected intensity of the cover layer may be about R=5%. The refractive index of the cover layer, if applied, is 1.6. The focal length is approximately 1.5 mm, the NA is 0.85 and wavelength λ is 405 nm. The double-Foucault detection prism has a deflection angle of 1.9 degrees and a focal length of 60 mm and the detectors are located 30 mm behind the prism. It is to be noted that other methods than the double Foucault method of generating a FES can be applied.

FIG. 6 shows a simple FES S-curve as obtained for a disc without cover layer and a first-surface recording (left curve) and a similar FES S-curve for a disc with a very thin transparent cover layer, for example 1 μm (right curve). In the latter case, the zero crossing ZC of the negative slope of the S-curve is at 0.4 μm which is offset with respect to the proper value of 1/1.6=0.625 μm for the cover/data layer interface CDI. In FIG. 6, arrows are used to indicate the zero crossing ZC, the air/cover interface ACI, the cover/data layer interface CDI and the air/data layer interface ADI. If the thickness of the cover layer is close to or larger than the wavelength, interference effects may occur if the focal depth is close to or larger than the cover layer thickness. In such cases a different shape of curve for the FES may occur due to interference depending e.g. on the focal length of the system.

FIG. 7 shows a distorted (double) S-curve which was obtained for a disc with a cover layer several times thicker than the focal depth, e.g. 10 μm in this example. This FES S-curve crosses zero only once at an actual focus position (fp) of 5 μm, which should be compared to the data layer location at 6.25 μm corresponding to a cover layer thickness divided by the refractive index n of cover layer. From the reduced steepness of the second part of the S-curve of FIG. 7, it can be concluded that this difference is partly due to spherical aberration by the cover layer.

FIG. 8 shows another distorted S-curve as obtained for a disc with a 20 μm cover layer and which has negative slopes with two zero crossings NZC, one corresponds to the cover layer and the other to the data layer.

From FIGS. 7 and 8 it is clear that two strategies according to the first and second preferred embodiments are possible to obtain proper focus on the data layer.

According to the first preferred embodiment, in case of a situation similar to FIG. 7, instead of the signal reference level zero crossing, two crossing signal levels for servo lock can be preset, the first at normalized FES of +0.5 and the second at a normalized FES of approximately −0.5, corresponding to the cover layer and data layer respectively. The focus servo loop may than first lock onto the first spatial level and then push the focus actuator 11 towards the data layer and lock on the second spatial level.

According to the second preferred embodiment, in case of a situation similar to FIG. 8, a single reference signal level can be maintained in principle, i.e. the zero level for example. This may be advantageous for much thicker cover layers. Here, the focus servo loop may first lock onto the first negative-slope zero crossing and then push the focus actuator 11 towards the data layer and lock on the second negative-slope zero crossing.

Of course, any other suitable reference signal levels having a predetermined relationship to a desired focal level can be used in the proposed multi-step procedure. Furthermore, the move from the first spatial level to the second spatial level not necessarily has to be performed as a jumping operation but may be performed as well as slower or even slow movement. Additionally, the present procedure may be applied to change the focal point between more than two spatial levels in case of a multilayer recording scheme. The movement or jumping operations may be performed in both axial directions. Thus, various modifications may become apparent to those skilled in the art without departing from the scope of the invention as defined in the claims. The invention is applicable to any optical recording and reproducing devices having a focus control circuit.

In summary, a focus control scheme is proposed which improves robustness of initial focussing of a laser beam on an optical storage medium. When the objective means approaches the disc, the focus is locked onto a reflection signal stemming from a spatial reference level and is then pushed or moved by a predetermined amount related to the distance between the spatial reference level and a desired spatial level while the focus servo loop is opened. The result is that the focal point is now positioned on the desired spatial level. Then, the focus servo loop may be closed again to keep it there.

1. Focus control apparatus for controlling objective means (2) to focus a radiation beam onto a first spatial level of a record carrier (1), said apparatus comprising:
(a) a focus control loop having a detection means (6) for detecting a signal obtained from a reflection of said radiation beam at said record carrier (1), and an actuator means (11) for adjusting the position of said objective means (2) in response to said detected signal; and
(b) focus control means (7) for controlling said actuator means (11) to move said objective means (2) towards said record carrier (1), locking the focus to a reflection signal stemming from a second spatial level of said record carrier (1), opening said focus control loop, and controlling said actuator means (11) to move said objective means (2) by a predetermined amount related to a distance between said first and second spatial levels.

2. Apparatus according to claim 1, wherein said first spatial level corresponds to a surface of said record carrier (1) and said second spatial level corresponds to a data layer of said record carrier (1).

3. Apparatus according to claim 1, wherein said first spatial level corresponds to a data layer of said record carrier (1) and said second spatial level corresponds to an other data layer of said record carrier (1).

4. Apparatus according to claim 1, wherein multiple spatial levels exist in which any of said spatial levels can be selected as said first spatial level and any other spatial level can be selected as said second spatial level.

5. Apparatus according to claim 1, wherein said first spatial level corresponds to a first negative-slope zero crossing of a focus error signal detected by said detection means (6) and said second spatial level corresponds to second negative slope zero crossing of said focus error signal.

6. Apparatus according to claim 1, wherein said move of said objective means by said predetermined amount is achieved by a jump operation initiated by said focus control means (7).

7. Apparatus according to claim 4, wherein said jump operation is initiated by said focus control means (7) by applying a predetermined jump pulse to said actuator means (11).

8. An apparatus according to claim 1, wherein said predetermined amount corresponds to an effective optical thickness between said first and second spatial levels.

9. An apparatus according to claim 1, wherein said focus control means (7) is configured to close said focus control loop again after said move of said objective means (2) by said predetermined amount.

10. An apparatus according to claim 1, wherein said focus control means (7) is configured to control said actuator means (11) to reduce the relative velocity between said objective means (2) and said record carrier (1) to zero, when said locking to said second spatial level has been detected.

11. A disc player for at least one of reading from or writing to a record carrier (1), said disc player comprising a focus control apparatus as claimed in claim 1.

12. A disc player according to claim 9, wherein said record carrier is a magneto-optical domain-expansion disc (1).

13. A method of controlling focus of a radiation beam onto a first spatial level of a record carrier (1), said method comprising the steps of:
(a) locking a focus control loop onto a reflection signal obtained from a second spatial level located at a predetermined distance from said first spatial level;
(b) opening said focus control loop and moving an objective means (2) towards said second spatial level by a predetermined amount related to said predetermined distance; and
(c) closing said focus control loop again after said moving step.
